(19) United States
(12) Patent Application Publication
(10) Pub. No.: US 2006/0143094 A1
(43) Pub. Date: Jun. 29, 2006

(54) Providing purchasing opportunities for performances

(76) Inventors: Chris Michael Kohout, Seattle, WA (US); Kirby Watson, San Francisco, CA (US); Russ Whitman, Bothell, WA (US)

Correspondence Address: FISH & RICHARDSON P.C., P.O. BOX 1022, MINNEAPOLIS, MN, 55440-1022, US

(21) Appl. No.: 11/292,913

(22) Filed: Dec. 2, 2005

Related U.S. Application Data
(60) Provisional application No. 60/632,778, filed on Dec. 2, 2004.

(51) Int. Cl. G06Q 30/00

(52) U.S. Cl. 705/26

(57) ABSTRACT

In one general aspect, information associated with media residing on a client is identified. One or more performances are automatically retrieved from a network device. At least one performance associated with the identified media is identified based, at least in part, on the media information. The at least one performance is displayed to a user of the client.

### RELATED APPLICATION

This application claims the benefit of U.S. Provisional Application No. 60/632,778 filed Dec. 2, 2004.

### TECHNICAL FIELD

This invention relates to online sales and, more particularly, to providing purchasing opportunities for performances.

### BACKGROUND

Monitoring and/or identifying purchasing opportunities associated with a user's music or performance preferences can be challenging and require an excessive amount of time. For example, an individual that wants to attend a concert typically calls ticket providers and/or searches online for possible purchasing opportunities. Such efforts may require that the individual know precisely what entities to contact and what search parameters to provide. If such information is not known, an individual can spend an excessive amount of time to locate and purchase tickets to an event.

### SUMMARY

In one general aspect, information associated with media residing on a client is identified. One or more performances are automatically retrieved from a network device. At least one performance associated with the identified media is identified based, at least in part, on the media information. The at least one performance is displayed to a user of the client.

Implementations can include one or more of the following features. The media information comprises an identification of at least one artist. The one or more performances comprise a list of concerts. The one or more performances further comprise an indication of available tickets.

The details of one or more examples of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an event management system;

FIGS. 2A-2F illustrate displays for the event management system of FIG. 1; and

FIG. 3 is a flow diagram illustrating an example method for the event management system of FIG. 1.

Like reference symbols in the various drawings indicate like elements.

### DETAILED DESCRIPTION

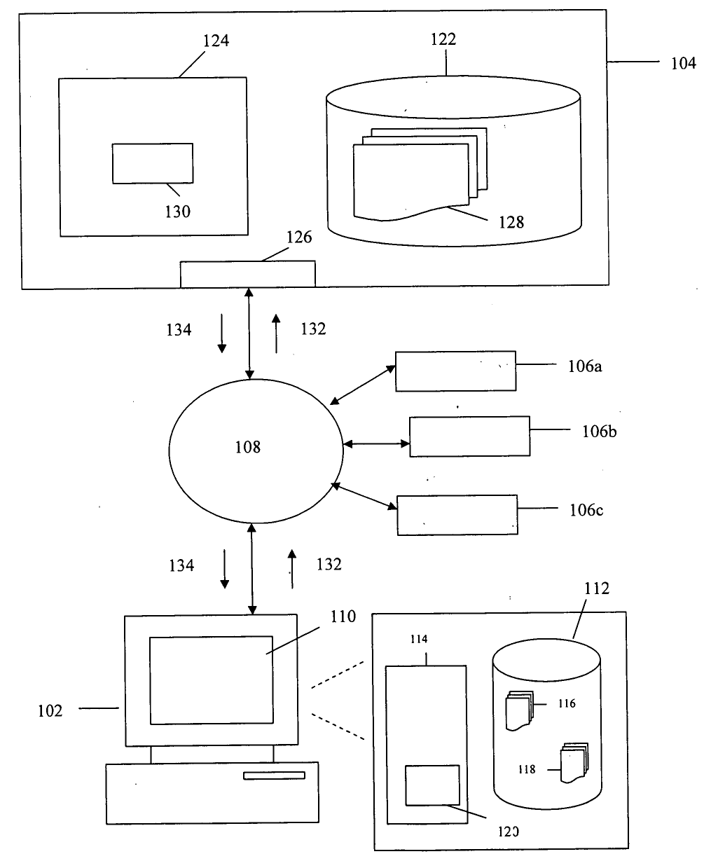

FIG. 1 is a block diagram for an event management system 100. In general, system 100 identifies and provides purchasing opportunities to a client 102 based, at least in part, on media residing on the client 102. Purchasing opportunities may include products, live performances, similar media, and other tangible and intangible items that an individual may purchase from a third-party. For example, the system 100 may identify a concert in which a particular band at a nearby location is performing based, at least in part, on an identification songs of the band residing on the client 102. At a high level, the system 100 operates in a distributed environment and provides purchasing opportunities to client 102. For example, the system 100 may automatically provide purchasing opportunities in response to at least identifying media residing on the client 102. Media, for example, may include image files, text files, audio files, video files audiovisual files, and/or other multimedia files. In the illustrated example, the system 100 includes a client 102, an event server 104, and opportunity providers 106 connected via a network 108. But the system 100 may be any other suitable computing environment. As a result, the system 100 may automatically inform a user of the client 102 of local concerts for artists that the user has shown an interest in through files stored on the client 102 or that are otherwise related to the stored files (through genre, subject matter, similar interest of other users, or any other relationship). Indeed, system 100 may allow the individual to reduce time and effort in pursuing their interest by proactively searching for purchasing opportunities.

The client 102 is typically a computer that requests and receives services and information from server 104 and opportunity providers 106 via network 108. In the illustrated example, client 102 includes a graphical user interface (GUI) 110, a memory 112, and a processor 114. It will be understood that there may be any number of clients 102 coupled to server 104. In general, the client 102 may include input devices, output devices, mass-storage media, processors, memory, interfaces, communication ports, or other suitable components for communicating requests to the server 104 and receiving responses via network 108. For example, the client 102 may comprise a computer that includes an input device, such as a keypad, touch screen, mouse, or other device that can accept information, and an output device that conveys information associated with the operation of the server 104 or the client 102, including digital data, visual information, or any other suitable information. Both the input device and output device may include fixed or removable storage media such as magnetic computer disk, CD-ROM, or other suitable media to both receive input from and provide output to users of the client 102 through a portion of a data display, namely GUI 110. As used in this document, the client 102 is intended to encompass a personal computer, a workstation, network computer, kiosk, wireless data port, personal data assistant (PDA), one or more processors within these or other devices, or any other suitable processing device. The present disclosure contemplates computers other than general purpose computers as well as computers without conventional operation systems.

The GUI 110 comprises a graphical user interface operable to allow the user of the client 102 to interface with at least a portion of system 100 for any suitable purpose. Generally, the GUI 110 provides the user of the client 102 with an efficient and user-friendly presentation of data provided by the system 100, such as charts and tables. The GUI 110 may comprise a plurality of displays having interactive fields, pull-down lists, and buttons operated by the user. It should be understood that the term “graphical user interface” may be used in the singular or in the plural to describe one or more graphic user interfaces in each of the displays of a particular graphical user interface. Further, the GUI 110 contemplates any graphical user interface, such as a generic web browser, that processes information in the system 100 and efficiently presents the information to the user. The server 104 can accept data from the client 102 via the web browser (e.g., Microsoft Internet Explorer or Netscape Navigator) and return the appropriate Hyper Text Markup Language (HTML) or eXtensible Markup Language (XML) responses. In addition, the GUI 110 provides an interface with the memory 112 and/or the processor 114 for exchanging information with the server 104.

The memory 112 may include any memory or database module and may take the form of volatile or non-volatile memory including, without limitation, magnetic media, optical media, random access memory (RAM), read-only memory (ROM), removable media, or any other suitable local or remote memory component. In this example, the illustrated memory 112 includes media profiles 116 and provider profiles 118, but may also include any other appropriate data.

Each media profile 116 includes entries or data structures that identify media residing on the client 102. For example, the media profile 116 may identify an artist, an album, a song, a date, a portion of the media file (e.g., sound wave pattern), and other information associated with the stored song. In another example, the media profile 116 may identify a movie, a director, a year, and other information associated with the stored movie. The media profile 116 may include one or more of the following: artist, band, lead singer, band members, genre, release date, stored date, frequency of use, director, title, actors, or other information associated with the media. Each media profile 116 may be associated with a single media file or multiple media profiles 116 may be associated with a single media file. The media profile 116 may be associated with a genre, an artist, a director, a time period, or other suitable categories. The media profile 116 may be any suitable format such as, for example, an eXtensible Markup Language (XML) document, a flat file, comma-separate-value (CSV) file, a name-value pair file, SQL table, an array, an object, or others. The media profile 116 may be dynamically created by the client 102, by a third-party vendor, or any suitable user of the client 102, loaded from a default file, or received via the network 108.

Each provider profiles 118 includes rules, instructions, parameters, algorithms, and/or other directives used by the client 102 to contact and retrieve purchasing opportunities from the opportunity provider 106. Each provider profile 118 may be associated with a particular provider 106, multiple providers 106, a type of provider, a group of providers, or multiple provider profiles 118 may be associated with a single provider 106. For example, the provider profile 118 may include a network address and identify the protocol and parameters necessary for searching and/or retrieving performances from the opportunity provider 106. Moreover, the provider profile 118 may include one or more of the following: a network address of the provider 106, a type of provider, a description of the provider 106, and other suitable information. The provider profiles 118 may be any suitable format such as, for example, a web page, an XML document, a flat file, CSV file, a name-value pair file, SQL table, or others. Further, the provider profiles 118 may be written in or based on any appropriate computer language including C, C++, Java, Visual Basic, HTML, Perl, and others.

The client 102 also includes the processor 114. The processor 114 executes instructions and manipulates data to perform the operations of the client 102 and may be any processing or computing component such as, for example, a central processing unit (CPU), a blade, an application specific integrated circuit (ASIC), or a field-programmable gate array (FPGA). Although FIG. 1 illustrates a single processor 114 in the cleint 102, multiple processors 114 may be used according to particular needs, and reference to the processor 114 is meant to include multiple processors 114 where applicable. The processor 114 executes the event engine 120, which identifies media residing in the client 102, retrieves purchasing opportunities from providers 106, and presents purchasing opportunities associated with the identified media to the user of client 102 via GUI 110.

The event engine 120 is any software, hardware, firmware, or combination thereof that is communicably coupled with the server 104 and/or the opportunity providers 106. For example, the event engine 120 may be operable to transmit information identifying media residing on client 102 to server 104 and/or providers 106. As a result, the transmitted information may identify (or be used to identify) purchasing opportunities associated with the identified media. In the music example, the event engine 120 may transmit information identifying a song, band, and frequency of use, indicating that the user may be interested in the identified band. In some examples, the event engine 120 retrieves from providers 106 available performances and identifying one or more performances by comparing identified media residing on client 102 with the retrieved performances. In this case, the identification of performances associated with media residing on the client 102 is performed by the event engine 120 as compared with providers 106. In some examples, event engine 120 receives a request from server 104 to identify media residing on the client 102. In response to the request, the event engine 120 determines or otherwise identifies the media profiles 116 and transmits information to the server 104 identifying the user's preferences. More particularly, the event engine 120 may identify some or all media, a genre, frequency of use, new media since previous request, artist, release date, download date, a combination of the foregoing, or other information associated with the media. Alternatively or in combination, the event engine 120 may periodically (e.g., 12 hrs., 1 day, 1 week, 1 month, 6 months) identify media residing on the client 102 and automatically transmit the information indicating the results to the server 104 and/or providers 106.

Further, the event engine 120 may be operable to receive purchasing opportunities from the server 104 and/or providers 106 and automatically present the purchasing opportunities to the user of the client 102 via GUI 110. The presentation may occur without interaction of a user of the client 102 and may not allow the user to prevent or reschedule the presentation. In some examples, the event engine 120 notifies the user that purchasing opportunities are available and provides a mechanism to accept, decline, or delay a presentation of the opportunities. For example, the user may be notified by a presentation, email, sound indicator, and/or other mechanism. The event engine 120 may be written in or based on any appropriate computer language including C, C++, Java, Visual Basic, Perl, and others. It will be understood that while the event engine 120 is illustrated as a single multi-tasked module, the features and functionality performed by this engine may be performed by multiple modules.

The server 104 includes the memory 122 and the processor 124 and is generally an electronic computing device operable to receive, transmit, process and store data associated with the system 100. As briefly discussed above, the memory 108 includes opportunity profiles 128 but may also include any other appropriate data.

Each opportunity profile 128 typically comprises entries or data structures operable to identify one or more purchasing opportunities associated with identified media. The opportunity profile 128 may comprise include one or more of the following: an artist, an address, a phone number, a URL, a band, a director, a title, dates, prices, available seating, type of venue, or other information associated with the purchasing opportunity. In the band example, the opportunity profile 128 may include a website, a date, venue type, prices, type of seating, prices, address, and phone number. It will be understood that the opportunity profile 128 may include information received from the providers 106, as well as include locally generated content. The opportunity profile 128 may be any suitable format such as, for example, an XML document, a flat file, CSV file, a name-value pair file, an SQL table, an HTML page, a text message, or others. In addition, content 212 may be written in or based on any appropriate computer language including C, C++, Java, Visual Basic, Perl, and others.

The server 104 also includes one or more processor 130. The processor 130 executes instructions and manipulates data to perform the operations of the server 104 such as, for example, a CPU, an ASIC or a FPGA. In the example illustrated, the server 104 includes the opportunity module 130. The opportunity module 130 is any hardware, software, firmware, or combination thereof operable to download purchasing opportunities from the providers 106, process requests from the client 102, and automatically transmit the purchasing opportunities to the client 102. For example, the opportunity module 130 may transmit requests to the providers 106 for purchasing opportunities associated with media. In another example, the providers 106 may independently provide this information to the opportunity module 130. In some examples, the opportunity module 130 directly retrieves from providers 106 available performances as compared to transmitting request for specific performances. In this case, the identification of performances associated with media residing on the client 102 is performed by the event engine 120 as compared with providers 106. In response to receiving an opportunity request 132, the opportunity module 130 identifies the opportunity profile 128 based, at least in part, on any appropriate criteria. For example, the opportunity request 132 may identify the opportunity profile 128 based on one or more of the following: an artist name, a band name, a song name, an album name, a genre, or other suitable information associated with media. After identifying the opportunity profile 128, the opportunity module 130 transmits an opportunity response 134 to the client 102. In certain examples, the opportunity module 130 automatically communicates the purchasing opportunities to the client 102 (often without request) upon updating the opportunity profile 128. The opportunity module 130 may be written in or based on any appropriate computer language including C, C++, Java, Visual Basic, Perl, and others. It will be understood that while the opportunity module 130 is illustrated as a single multi-tasked module, the features and functionality performed by these engine may be performed by multiple modules. The server 104 also includes communicates with other computer systems, such as the client 102 and/or providers 106, over network 108 in a client-server or other distributed environment.

The network 108 facilitates wireless or wireline communication between the client 102, the server 104, and the providers 106. Indeed, while illustrated as one network 108, the network 108 may be a plurality of communicably coupled networks 108, so long as at least portion of network 108 may facilitate communications between the client 102, the server 104, and the providers 106. For example, the client 102 may reside in a wireless or wireline intranet that is communicably coupled to the larger network, such as the Internet. In other words, the network 108 encompasses any internal or external network or networks, sub-network, or combination thereof operable to facilitate communications between various computing components in the system 100.

The network 108 may communicate, for example, Internet Protocol (IP) packets, Frame Relay frames, Asynchronous Transfer Mode (ATM) cells, voice, video, data, and other suitable information between network addresses. The network 108 may include one or more local area networks (LANs), radio access networks (RANs), metropolitan area networks (MANs), wide area networks (WANs), all or a portion of the global computer network known as the Internet, and/or any other communication system or systems at one or more locations.

Each opportunity provider 106 typically comprises a vendor, a server, an entity, an individual, or other resource that provides purchasing opportunities operable associated with media residing on client 102. For example, the opportunity provider 106a may comprise a vendor's web server that provides tickets for local concerts. In another example, the opportunity provider 106a may comprise a Usenet group that provides information associated with a touring band (e.g., Grateful Dead). In summary, content providers 204 may comprise a vendor (e.g., Ticket Master), a Usenet group, or any other suitable entity that provides purchasing opportunities.

In one aspect of operation, events are identified and/or generated by the content provider 106 or other vendor or entity. For example, a vendor may identify tickets that are available for a performance at a local venue. The event may be identified by artist name, band name, venue name, venue address, or other information. Once identified, a purchasing opportunity is generated and provided to the server 104 or directly to the client 102. In the illustrated example, the opportunity provider 106 provides the purchasing opportunity. Once available, the server 104 requests and/or retrieves the purchasing opportunity from the opportunity providers 106, and the opportunity module 130 generates the opportunity profile 128 for transmission to the client 102.

The event engine 120 identifies media resigning on the client 102 and generates and/or updates a particular media profile 116 using the identified information. At any appropriate time, the event engine 120 transmits an opportunity request 132 to the server 104 for purchasing opportunities associated with the identified media. Alternatively or in combination, the event engine 120 may identify provider profiles 118 and transmit the request directly to the providers 106 for purchasing opportunities. In some embodiments, the event engine 120 retrieves available performances from the providers 106 and identifies performances with media residing on client 102 by comparing the media to the retrieved information. In response to receiving purchasing opportunities from the server 104 and/or providers 106, the event engine 120 generates a presentation including the opportunities and displays the presentations via GUI 110.

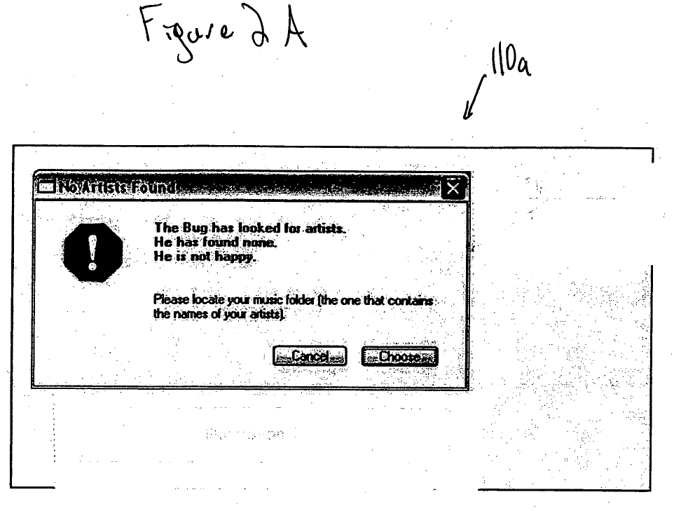

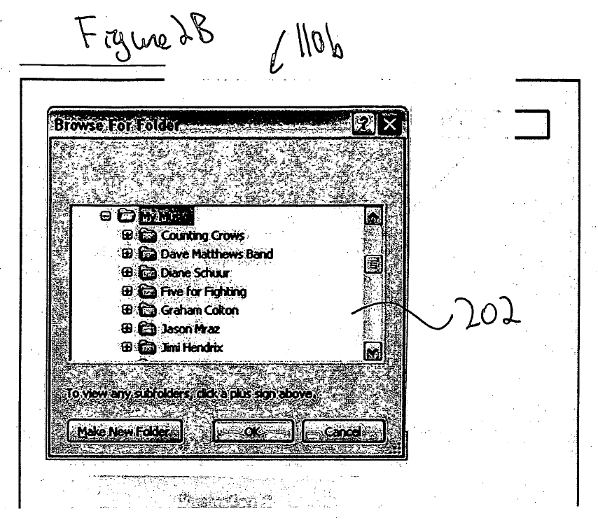

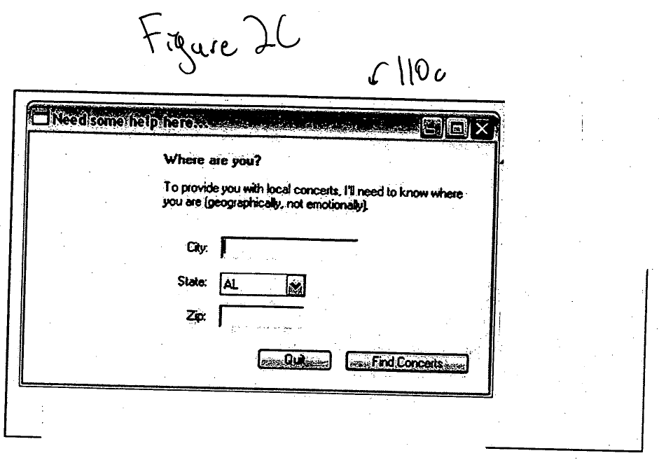

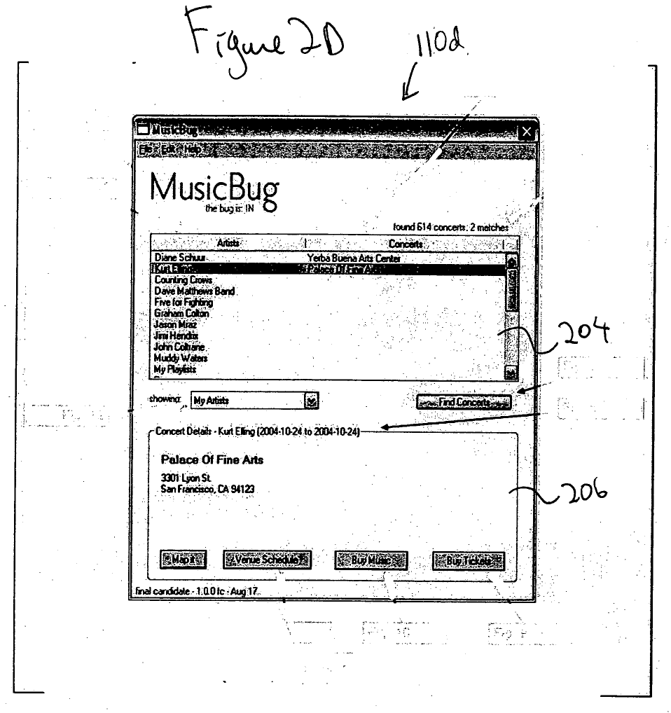

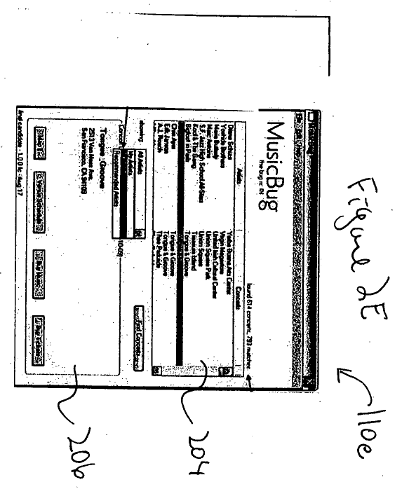

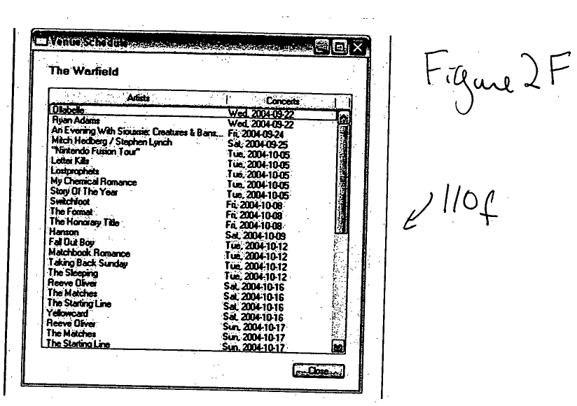

FIGS. 2A-2F are example displays for managing purchasing opportunities in accordance with one embodiment of system 100. It will be understood that illustrated web pages 110a-110f, respectively, are for example purposes only. Accordingly, GUI 110 may include or present data, such as media list, opportunities or venue schedules, in any format or descriptive language and each page may present any appropriate data in any layout without departing from the scope of the disclosure.

Turning to the illustrated embodiments, FIG. 2A illustrates an example warning view 110a. In this view 110a, the user is alerted that the event engine 120 was unable to locate any media files residing on the client 102. In this case, the view 110a may provide a mechanism for the user to identify the media files residing on the client 102. For example, the view 110a may provide a graphical button for the user to select to enable the user to identify the media files. In some example, the event engine 120 provides the view 110b in response to the user selecting the graphical button selected in the view 110a.

FIG. 2B illustrates an example browse view 110b. In this view 110b, the user may navigate through the local directory of client 102 and identify media files residing on client 102. The illustrated view 110b includes a tree structure 202 for navigating through the local directory. The tree structure 202 provides typical tree processing such as collapsing and/or expanding nodes to facilitate navigating through files. The view 110b also provide graphical buttons to enable the user to perform additional actions. In the illustrated embodiment, the view 110b provides the following graphical buttons: make new folder, ok, and cancel.

FIG. 2C illustrates an example location view 110c. In this view 110c, the user may provide their location to the event engine 120 for determining nearby events such as concerts. The illustrated view 110c provides fields for city and zip code. In these fields, the user may type in the associated information. In addition, the illustrated view 110c includes a drop-down menu enabling the user of client 102 to select a state. After providing the user's location to the event engine 120, the event engine 120 may present view 110d for displaying a list of available events.

FIG. 2D illustrates an example concert view 110d. In this view 110d, the user may be provided with a list of events based on the stored media and provided actions that may be performed such as purchase tickets. The illustrated view 110d includes a table 204 including two columns: artist and concerts. In particular, the artist column list the artist identified by the event engine 120 based on the media residing on the client 102 and the second column list available local concerts for the identified artist. The illustrated view also includes a pane 206. The pane 206 provides additional information regarding concert for the selected artist in the table 204. As illustrated, the pane 206 provides the venue and the address for the concert for the selected artist. The user may also be provided possible actions that may be selected through graphical buttons. The pane 206 provides the following graphical buttons: map it, venue schedule, buy music, and buy tickets. For example, the user may select to purchase tickets for the displayed concert. In selecting the “buy tickets” button, the even engine 120 may transmit a request to a particular provider 106 to fulfill the purchase request. In the event that the user would like to view all available local concerts, the user may select available concerts in the drop down menu 208. In this case, the even engine 120 may present view 110e.

FIG. 2E illustrates an example local concert view 110e. In this view 110e, the user is provided a listing of all local concerts and associated artist via the table 204. In this case, the artist column in the table 204 list the artists performing local concerts. In this case, the client 102 may not store media associated with at least some of the artist displayed in the column. The pane 206 again provides the graphical buttons as discussed above enabling the user of client 102 to perform actions in response to the displayed information. For example, the user may select the venue schedule button, and, in response to the selection, the event engine 120 may present the view 110f.

FIG. 2F illustrates an example venue view 110f. In the view 110f, the user is provided with a venue schedule. The illustrated view 110f includes a table 210. The table 210 includes two columns: artists and concerts. The artist column provides the artist name that will be performing at the particular venue. The concerts column provides the day and date that the artist will be performing.

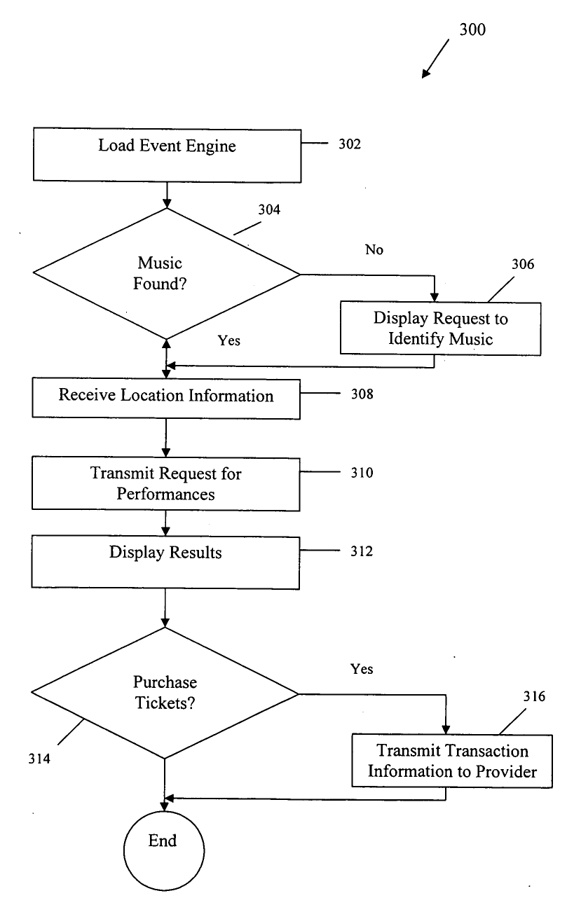

FIG. 3 illustrates a flow diagram implementing an example process for using management system 100 of FIG. 1 to identify purchasing opportunities. Process 300 is described with respect to management system 100 of FIG. 1, but process 300 could be used by any other application or applications. Thus, many of the steps in this flowchart may take place simultaneously and/or in different orders as shown. Further, management system 100 may execute logic implementing techniques similar to one or both of process 300 in parallel or in sequence. Management system 100 may also use processes with additional steps, fewer steps, and/or different steps, so long as the processes remain appropriate.

Method 300 begins at step 302 where the client 102 loads the event engine 120. If the music files are not phallic that decisional step 302, then, at step 306, the event in Jane 120 displays a request to the user to identify the music residing all on client 102. Execution proceeds to step 308 where the event engine 120 receives location information of the user. At step 310, the event engine 120 transmits a request for performances to the server 104 and/or the providers 106. Next, at step 312, the event engine 120 displays a list of performances received from the server 104 and/or the providers 106 and associated with the music residing on the client 102. If the user selects to purchase tickets for particular performance at decisional step 314, then, at step 316, the event in Jane 120 transmits transaction information to the associated provider 106.

Although this disclosure has been described in terms of certain embodiments and generally associated methods, alterations, and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method, comprising:
receiving information that identifies media residing on a client;
automatically identifying one or more performances based, at least in part, on the media information by comparing the media information to information associated with the one or more performances, at least a portion of the performance information collected from a third party providers; and
transmitting the one or more opportunities to the client.

2. The method of claim 1, wherein the media information comprises an identification of at least one artist.

3. The method of claim 1, wherein the one or more performances comprise a list of concerts.

4. The method of claim 3, wherein the one or more performances further comprise indication of available tickets.

5. A method, comprising:
identifying information associated with media residing on a client;
automatically retrieving one or more performances from a network device;
identifying at least one performance associated with the identified media based, at least in part, on the media information; and
displaying the at least one performance to a user of the client.

6. The method of claim 5, further comprising:
receiving a selection from the user identifying the at least performance; and
transmitting a request for the at least performance to the network device.

7. An article comprising a machine-readable medium storing instructions for causing data processing apparatus to perform operations comprising:
receiving information that identifies media residing on a client;
automatically identifying one or more performances based, at least in part, on the media information by comparing the media information to information associated with the one or more performances, at least a portion of the performance information collected from a third party providers; and
transmitting the one or more opportunities to the client.

8. The article of claim 7, wherein the media information comprises an identification of at least one artist.

9. The article of claim 7, wherein the one or more performances comprise a list of concerts.

10. The article of claim 9, wherein the one or more performances further comprise indication of available tickets.

11. An article comprising a machine-readable medium storing instructions for causing data processing apparatus to perform operations comprising:
identifying information associated with media residing on a client;
automatically retrieving one or more performances from a network device;
identifying at least one performance associated with the identified media based, at least in part, on the media information; and
displaying the at least one performance to a user of the client.

12. The article of claim 11, the instructions further causing data processing apparatus to perform operations comprising:
receiving a selection from the user identifying the at least performance; and
transmitting a request for the at least performance to the network device.

13. A system, comprising:
memory operable to store performances; and
one or more processors operable to:
receive information that identifies media residing on a client;
automatically identify one or more performances based, at least in part, on the media information by comparing the media information to information associated with the one or more performances, at least a portion of the performance information collected from a third party providers; and
transmit the one or more opportunities to the client.

14. The system of claim 13, wherein the media information comprises an identification of at least one artist.

15. The system of claim 13, wherein the one or more performances comprise a list of concerts.

16. The system of claim 15, wherein the one or more performances further comprise indication of available tickets.

17. A system, comprising:
memory operable to store media; and
one or more processors operable to:
identify information associated with media residing on a client;
automatically retrieve one or more performances from a network device;
identify at least one performance associated with the identified media based, at least in part, on the media information; and
display the at least one performance to a user of the client.

18. The system of claim 17, the processors further operable to:
receive a selection from the user identifying the at least performance; and
transmit a request for the at least performance to the network device.

19. A method comprising:
identifying information associated with media residing on a client;
automatically transmitting the media information to a network device operable to identify performances based, at least in part, on the media information;
receiving the media information that identifies media residing on the client;
automatically identifying one or more performances based, at least in part, on the media information by comparing the media information to information associated with the one or more performances, at least a portion of the performance information collected from a third party providers;
transmitting the one or more opportunities to the client
receiving a response including performances associated with the media; and
displaying the performances to a user of the client.

20. The method of claim 19, further comprising:
receiving a selection from the user identifying at least one of the performances; and
transmitting a request for the at least one of the performances to the network device.
